(19) United States
(12) Patent Application Publication
(10) Pub. No.: US 2026/0318254 A1
(43) Pub. Date: Oct. 15, 2026

(54) PREDICTIVE EMISSION CONTROL FOR TURBINE ENGINES

(71) Applicant: Siemens Energy Global GmbH & Co. KG, München (DE)

(72) Inventor: Andrew Dawson, Fenton, Newark (GB)

(21) Appl. No.: 19/485,284

(22) PCT Filed: Apr. 18, 2024
(86) PCT No.: PCT/US2024/025121

§ 371 Date: Nov. 18, 2025

(30) Foreign Application Priority Data
May 23, 2023 (GB) 2307682.1

(51) Int. Cl. F02C 9/40; F02C 9/22

(52) U.S. Cl. CPC F02C 9/40; F02C 9/22; F05D 2260/81; F05D 2270/08

(57) ABSTRACT

A turbine engine includes a model configured to predictively determine a behavior of emissions of the turbine engine. A controller operatively responsive to the model to influence respective emissions levels of the emissions of the turbine engine at least based on the determined behavior of the emissions. A fuel supply arrangement of the turbine engine in combination with either a bleed valve arrangement or an inlet guide vane arrangement of the compressor are concurrently adjusted by the controller so that the respective emissions levels of the emissions of the turbine engine are influenced during operation of the turbine to meet the desired emission-abatement strategy.

### BACKGROUND

Disclosed embodiments relate to turbomachinery, such as may involve a gas turbine engine, and, more specifically, to emission control techniques so that respective emissions levels of the turbine engine are influenced during operation of the turbine engine to meet a desired emission-abatement strategy.

It is known that industrial plants, for example, produce not just vast amounts of energy but also emissions, like nitrogen oxides (NOₓ), carbon oxides (COₓ), unburned hydrocarbons, etc., that can be harmful to humans and other animals as well as to the environment. Thus, substantial efforts are made to reduce these pollutants.

Continuous monitoring of plant emissions may be done by either Automated Emission Monitoring Systems (AEMS), which is a direct continuous method of emissions measurement, or by a Predicted Emissions Monitoring System (PEMS), which uses appropriate process parameters to calculate (i.e., predict) emission levels. Out of the foregoing approaches, PEMS has a relatively lower operating costs and reduced complexity of operation. For one example of emissions control involving a PEMS model, see EP 3 012 694 B1.

### BRIEF SUMMARY

In one aspect, a turbine engine includes a first memory storing a model of systems of the turbine engine. The model is configured to predictively determine a behavior of emissions of the turbine engine. A controller is operatively responsive to the model to influence respective emissions levels of the emissions of the turbine engine at least based on the determined behavior of the emissions. A fuel supply arrangement of the turbine engine. A bleed valve arrangement of the compressor. A second memory storing a desired emission-abatement strategy. A split ratio of a main fuel and a pilot fuel of the fuel supply arrangement and a bleed angle of the bleed valve arrangement are concurrently adjusted by the controller in accordance with the desired emission-abatement strategy so that the respective emissions levels of the emissions of the turbine engine are influenced during operation of the turbine to meet the desired emission-abatement strategy.

In another aspect, a turbine engine includes a first memory storing a model of systems of the turbine engine. The model is configured to predictively determine a behavior of emissions of the turbine engine. A controller is operatively responsive to the model to influence respective emissions levels of the emissions of the turbine engine at least based on the determined behavior of the emissions. A fuel supply arrangement of the turbine engine. An inlet guide vane arrangement of the compressor. A second memory storing a desired emission-abatement strategy. A split ratio of a main fuel and a pilot fuel of the fuel supply arrangement and a respective angle of the variable inlet guide vane arrangement are concurrently adjusted by the controller in accordance with the desired emission-abatement strategy so that the respective emissions levels of the emissions of the turbine engine are influenced during operation of the turbine to meet the desired emission-abatement strategy.

In still another aspect, a computer-implemented method in a turbine engine including a compressor, a fuel supply arrangement for the turbine engine, and a bleed valve arrangement of the compressor. A non-transitory computer readable medium is programmed with computer-readable code so that when a computer processor executes the computer-readable code, the computer processor performs the following: run a model stored in a first memory to predictively determine a behavior of emissions of the turbine engine, operatively couple a controller to the model to influence respective emissions levels of the emissions of the turbine engine at least based on the determined behavior of the emissions, access a second memory storing a desired emission-abatement strategy, and concurrently adjust by way of the controller a split ratio of a main fuel and a pilot fuel of the fuel supply arrangement and a bleed angle of the bleed valve arrangement in accordance with the desired emission-abatement strategy so that the respective emissions levels of the emissions of the turbine engine are influenced during operation of the turbine to meet the desired emission-abatement strategy. The desired emission-abatement strategy is arranged to provide a balanced compromise amongst the respective emissions levels of the emissions of the turbine engine.

In yet still another aspect, a computer-implemented method in a turbine engine including a compressor, a fuel supply arrangement for the turbine engine, and an inlet guide vane arrangement of the compressor. A non-transitory computer readable medium is programmed with computer-readable code so that when a computer processor executes the computer-readable code, the computer processor performs the following: run a model stored in a first memory to predictively determine a behavior of emissions of the turbine engine, operatively couple a controller to the model to influence respective emissions levels of the emissions of the turbine engine at least based on the determined behavior of the emissions, access a second memory storing a desired emission-abatement strategy, and concurrently adjust by way of the controller a split ratio of a main fuel and a pilot fuel of the fuel supply arrangement and a respective angle of the variable inlet guide vane arrangement in accordance with the desired emission-abatement strategy so that the respective emissions levels of the emissions of the turbine engine are influenced during operation of the turbine to meet the desired emission-abatement strategy. The desired emission-abatement strategy is arranged to provide a balanced compromise amongst the respective emissions levels of the emissions of the turbine engine.

### BRIEF DESCRIPTION OF THE SEVERAL VIEWS OF THE DRAWINGS

Disclosed embodiments will be described with reference to drawings in which:

FIG. 1 shows a schematically and sectional representation of an example turbine engine, such as a gas turbine engine, that can benefit from disclosed embodiments,

FIG. 2 shows a flow diagram of a chemical kinetic model and a parametrization model that may be respectively executed by a suitable processor unit of the turbine engine from FIG. 1,

FIG. 3 shows a non-limiting example of a simplified conceptual analysis of elements of the chemical kinetic model of FIG. 2,

FIG. 4 shows a schematic representation of one disclosed embodiment where a fuel supply arrangement and a variable inlet guide vane arrangement are concurrently adjusted by a controller to achieve a desired emission-abatement strategy,

FIG. 5 shows a diagram depicting an example relationship of NOx emissions with respect to a combustor entry temperature obtained with the chemical kinetic model from FIG. 2,

FIG. 6 shows a diagram depicting an example relationship of NOx emissions with respect to a pilot/main split ratio obtained with the chemical kinetic model from FIG. 2,

FIG. 7 shows a flow diagram representation in connection with the disclosed embodiment shown in FIG. 4,

FIG. 8 is a schematic representation of another disclosed embodiment where the fuel supply arrangement and a variable inlet guide vane arrangement are concurrently adjusted to achieve the desired emission-abatement strategy, and

FIG. 9 shows a flow diagram in connection with the disclosed embodiment shown in FIG. 8.

### DETAILED DESCRIPTION

The inventor of the present invention has recognized that traditional emission control techniques typically involve setting a desired control temperature reference within a controller of a turbine engine. This control temperature reference is then maintained by manipulating combustion parameters, such as air flow, fuel flow, etc. The set point for the control temperature reference is picked from experimental data, or from field/factory tests and includes a sufficiently wide margin to account for deviations, inaccuracies that can be encountered in a real-world turbine engine. Although the wide margin in the set point for the control temperature reference considers variations that may occur, such as ambient temperature variations, engine operating pressure and flow variation, in general, this is a suboptimal technique to influence the emissions of the turbine engine consistently and accurately. For example, the wide margin for the set point means that in certain situations extra manipulations of the involved combustor parameters may be involved, and in turn this can result in excessive fuel consumption and hence potentially higher CO2 emissions than would be desirable despite that, for example, other emissions, such as CO and NOx emissions could be under appropriate limits.

At least in view of the foregoing considerations, disclosed embodiments involve utilization of a PEMS model in the control system of the engine so that a fuel supply arrangement of the turbine engine in combination with either a bleed valve arrangement or an inlet guide vane arrangement of the compressor are concurrently adjusted by a disclosed controller so that the respective emissions levels of the emissions of the turbine engine are influenced during operation of the turbine to meet a desired emission-abatement strategy. A basic idea behind the emissions control executed by disclosed embodiments is achieving, in a cost-effective and reliably manner, a balanced compromise amongst the respective emissions levels of the emissions of the turbine engine. That is, the emission control executed by disclosed embodiments is conducive to an optimally balanced compromise amongst the levels of Nox, CO and CO2, for example.

Before disclosed embodiments are explained in detail, it is to be understood that disclosed embodiments are not limited in their application to the details of construction and the arrangement of components set forth in this description or illustrated in the following drawings. Disclosed embodiments are capable of being practiced or of being carried out in various ways. Also, it is to be understood that the phraseology and terminology used herein is for the purpose of description and should not be regarded as limiting.

Various technologies that pertain to disclosed embodiments will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

It should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean that an element is relatively near to but not in contact with a further element or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

It is noted that while the instant disclosure includes a description in the context of a fully functional system and/or a series of acts, those skilled in the art will appreciate that at least portions of the mechanism of the present disclosure and/or described acts may be capable of being distributed in the form of computer/processor executable instructions (e.g., software/firmware applications) contained within a storage device that corresponds to a non-transitory machine-usable, computer-usable, or computer-readable medium in any of a variety of forms (e.g., flash memory, SSD, hard drive). The computer/processor executable instructions may include a routine, a sub-routine, programs, applications, modules, libraries, and/or the like. Further, it should be appreciated that computer/processor executable instructions may correspond to and/or may be generated from source code, byte code, runtime code, machine code, assembly, Java, JavaScript, Python, Rust, Swift, Go, C, C #, C++ or any other form of code that can be programmed/configured to cause at least one processor to carry out the acts and features described herein. Still further, results of the described/claimed processes or functions may be stored in a computer-readable medium, displayed on a display device, and/or the like.

It should be appreciated that acts associated with the above-described methodologies, features, and functions (other than any described manual acts) may be carried out by one or more data processing systems via operation of one or more of the processors. Thus, it is to be understood that when referring to a data processing system or control system such a system may be implemented across several data processing systems organized in a distributed system in communication with each other directly or via a network.

As used herein a processor or processor module corresponds to any electronic device that is configured via hardware circuits, software, and/or firmware to process data. For example, processors described herein may correspond to one or more (or a combination) of a microprocessor, CPU, or any other integrated circuit (IC) or other type of circuit that is capable of processing data in a data processing system. As discussed previously, the processor that is described or claimed as being configured to carry out a particular described/claimed process or function may correspond to a CPU that executes computer/processor executable instructions stored in a memory in the form of software to carry out such a described/claimed process or function. However, it should also be appreciated that such a processor may correspond to an IC that is hardwired with processing circuitry (e.g., an FPGA or ASIC IC) to carry out such a described/claimed process or function. Also, it should be understood, that reference to a processor may include multiple physical processors or cores that are configured to carry out the functions described herein. In addition, it should be appreciated that a data processing system and/or a processor may correspond to a controller that is operably configured to control at least one operation including a programable logic controller (PLC).

In addition, it should also be understood that a processor or processor module that is described or claimed as being configured to carry out a particular described/claimed process or function may correspond to the combination of the processor with the executable instructions (e.g., software/firmware applications) loaded/installed into the described memory (volatile and/or non-volatile), which are currently being executed and/or are available to be executed by the processor to cause the processor to carry out the described/claimed process or function. Thus, a processor that is powered off or is executing other software, but has the described software loaded/stored in a storage device in operative connection therewith (such as in a flash memory, SSD, or hard drive) in a manner that is available to be executed by the processor (when started by a user, hardware and/or other software), may also correspond to the described/claimed processor that is operably configured to carry out the particular processes and functions described/claimed herein.

Those of ordinary skill in the art will appreciate that hardware and software depicted in connection with disclosed embodiments may vary for particular implementations. The depicted examples are provided for the purpose of explanation only and are not meant to imply architectural limitations with respect to the present disclosure. Also, those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system may conform to any of the various current implementations and practices known in the art.

The terms upstream and downstream refer to the flow direction of the airflow and/or working gas flow through a turbine engine 10 unless otherwise stated. If used and not otherwise stated, the terms axial, radial and circumferential are made with reference to a rotational axis 30 of the turbine engine 10.

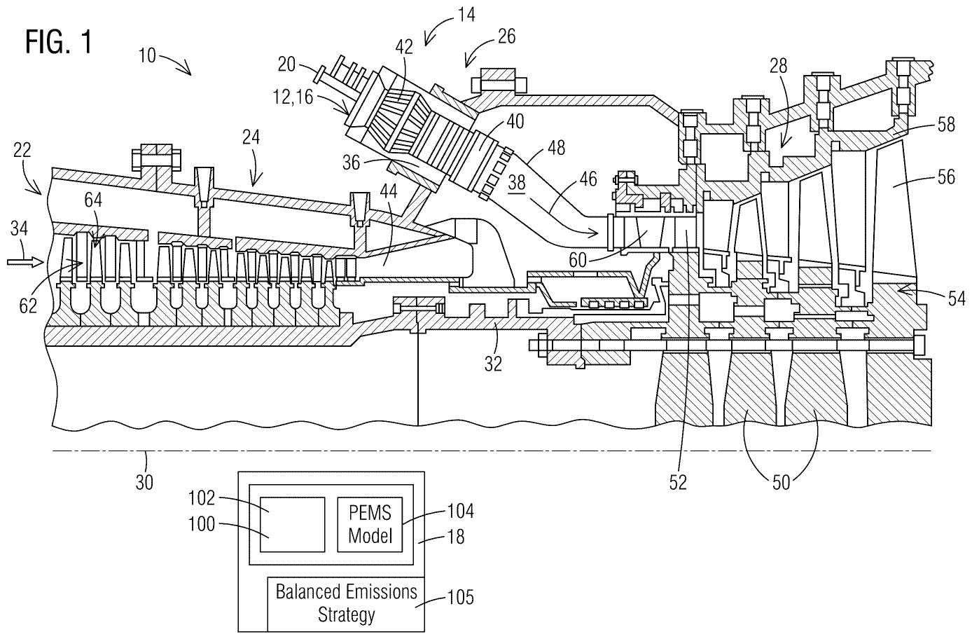

FIG. 1 shows an example of turbine engine 10, such as a gas turbine engine, in sectional view. The turbine engine 10 comprises, in flow series, an inlet 22, a compressor section 24, a combustion section 26 and a turbine section 28, which are generally arranged in flow series and generally in the direction of a longitudinal or rotational axis 30. The turbine engine 10 further comprises a shaft 32 which is rotatable about the rotational axis 30 and which extends longitudinally through the turbine engine 10. The shaft 32 drivingly connects the turbine section 28 to the compressor section 24.

In operation of the turbine engine 10, air 34, which is admitted through the air inlet 22 is compressed by the compressor section 24 and delivered to the combustion section or burner section 26. The burner section 26 comprises a combustion system 14 with a burner plenum 36, one or more combustion chambers 38 defined by a double wall can 40 and at least one burner 42 fixed to each combustion chamber 38. The combustion chamber(s) 38 and the burner(s) 42 are located inside the burner plenum 36. The compressed air passing through the compressor section 24 enters a diffuser 44 and is discharged from the diffuser 44 into the burner plenum 36 from where a portion of the air enters the burner 42 and is mixed with a gaseous or liquid fuel. The air/fuel mixture is then burned and the combustion gas 46 or working gas from the combustion is channeled via a transition duct 48 to the turbine section 28.

The turbine section 28 comprises a number of blade-carrying discs 50 or turbine wheels attached to the shaft 32. In the present example, the turbine section 28 comprises four discs 50 each carry an annular array of turbine blades 52. However, the number of blade-Docket carrying discs 50 could be different, e.g., just one blade-carrying disk 50 or more than one blade-carrying disk 50. In addition, stator stages or turbine cascades 54 are disposed between the turbine blades 52. Each stator stage carries an annular array of guiding vanes 56, which are fixed to a stator 58 of the turbine engine 10. Between the exit of the combustion chamber 38 and the leading turbine blades 52 inlet guiding vanes or nozzle guide vanes 60 are provided.

The combustion gas 46 from the combustion chamber 36 enters the turbine section 28 and drives the turbine blades 52 which in turn rotate the shaft 32. The guiding vanes 56, 60 serve to optimize the angle of the flow of the combustion or working gas 46 on to the turbine blades 52. The compressor section 24 comprises an axial series of guide vane stages 62 and rotor blade stages 64 with turbine blades 52 or vanes 56, respectively.

A PEMS model, as may be stored in a first memory 104, is achieved through the modelling of selected systems of the turbine engine 10, like combustion system 14 of the turbine engine 10. In one example embodiment, the modelling uses a chemical kinetics (CK) model 102 that utilizes the same input parameters or state variables P0, P1, P2, P3, P4, T0, T1, T2, T3, T4, T5, P2B, MCI, TFIRE, QF, QH, QT, SPLIT, Θbleed, ΘVIGV (see below) as the final PEMS model. In one example embodiment, the CK model 102 results are converted into mathematical functions which can be used to predict emissions without the need for online running of the CK model 102.

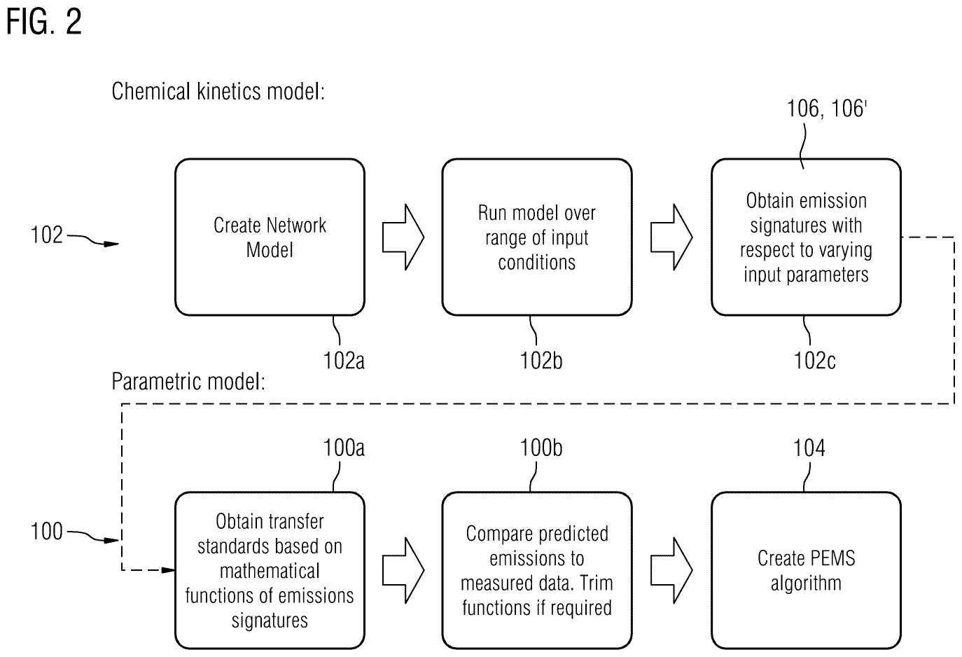

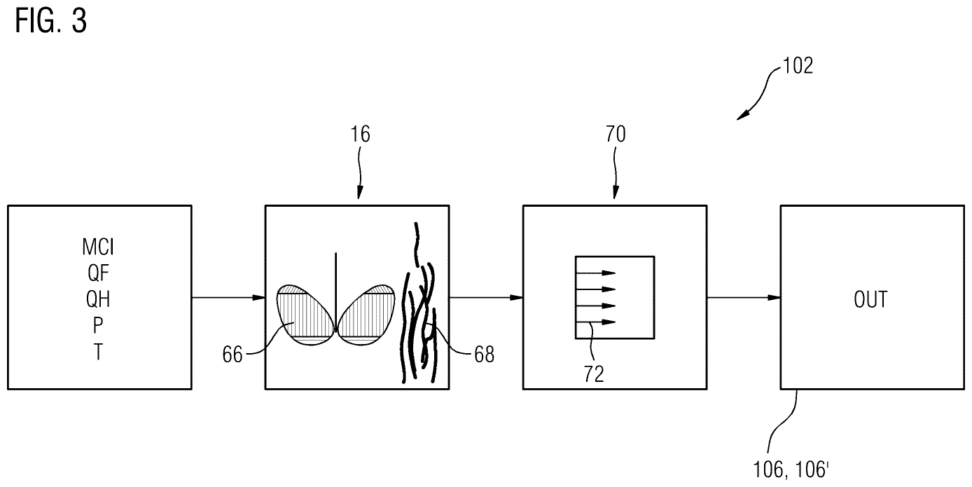

A process to develop PEMS model is depicted in the flow diagram of FIG. 2. For developing the CK model 102 describing, for example, a specific combustion system 14 of the turbine engine 10, a suitable network model of the combustion system 14 is created (step 102a). Therefore, certain key parts or components 12 of the combustion process are identified. These key components 12 are represented by separate model components or analysis elements. This is exemplarily shown in abbreviated form for two components in FIG. 3 (also see FIG. 1). A first components 12 may be, for example, a combustion primary zone 16 being represented, for example, by a series of perfectly-stirred reactor (PSR) 66 model elements, where main and pilot flames 68 are modelled separately (allowing the effect of main/pilot split to be investigated). A further component 12 may be located in a downstream combustion zone 70 and may be represented, for example, by plug-flow reactor (PFR) 72 model elements.

Additional key components 12 would be represented, for example, by appropriate mass flow merger model elements representing dilution and mixing of the various modelled gas streams, for example air or combustion products, or fuel, or by a mass flow splitter element or a flow resistance element. Boundary conditions (For example, how big is the volume of selected components or how much time is available for different processes) would be represented by boundary model elements (not shown).

As could be seen in FIG. 3 at least one selected first state variable MCI is used as an input of the model 102. While this is defined as a ‘mass flow’ inlet, it also contains selected pressures P, selected temperatures T, the fuel composition QH and the flow QF due to that the ‘mass flow’ inlet is a thermodynamically derived parameter. Other possible selected first state variables are P0, P1, P2, P3, P4, T0, T1, T2, T3, T4, T5, P2B, TFIRE, QF, QH, QT, SPLIT, Θbleed, ΘVIGV. The foregoing variables can be directly measured parameters, inferred parameters or thermodynamically derived parameters.

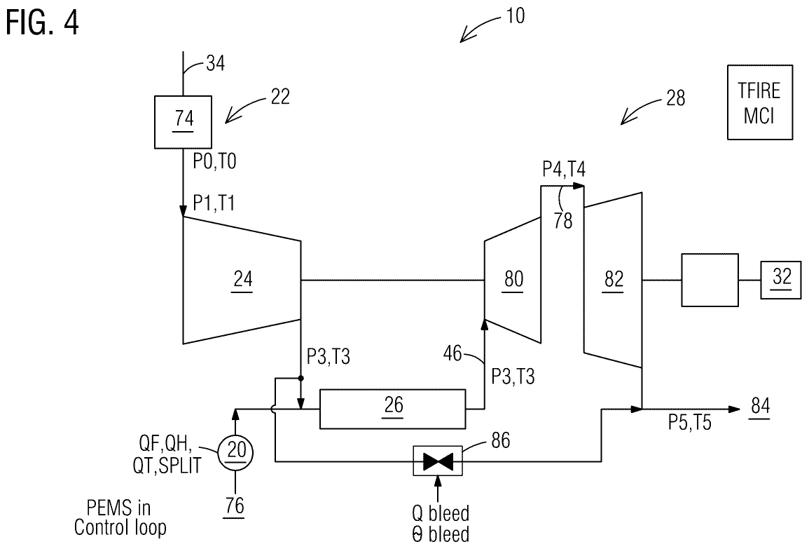

FIG. 4 shows a schematic representation of one disclosed embodiment where a fuel supply arrangement 20 and a bleed valve arrangement 86 are concurrently adjusted to achieve a desired emission-abatement strategy.

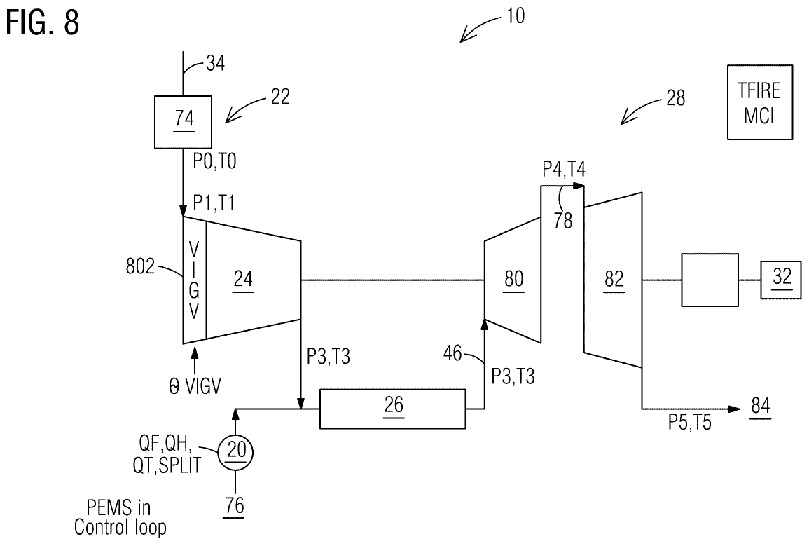

FIG. 4 shows various engine locations and associated conditions. FIG. 4 further shows where state variables P0, P1, P2, P3, P4, T0, T1, T2, T3, T4, T5, P2B, MCI, TFIRE, QF, QH, QT, SPLIT, Θbleed, ΘVIGV (FIG. 8) of the chemical kinetic model 102 may be obtained. Before entering the turbine engine 10, ambient air 34 has an ambient pressure and an ambient temperature (not specifically depicted with reference numerals). At the inlet 22 the air 34 traveling through a filter housing 74 has engine inlet pressure P0 and engine inlet temperature T0. Air entering a compressor of the compressor section 24 has compressor inlet pressure P1 and compressor inlet temperature T1. P2 is the compressor exit pressure, also named combustion chamber inlet pressure P2 or compressor delivery pressure P2, and T2 is the compressor exit temperature, also named combustion chamber inlet temperature T2 or compressor delivery temperature T2. Variable referring to the fuel 76 and the fuel supply arrangement 20 are a fuel flow QF, fuel composition QH, a fuel temperature QT and a main and pilot fuel split ratio SPLIT. Combustion gas 46 exiting the combustion section 26 has combustor exit pressure P3 and combustor exit temperature T3. Flow medium traveling through an interduct 78 located between a compressor turbine 80 and a power turbine 82 of the turbine section 28 has turbine interduct pressure P4 and turbine interduct temperature T4. An exhaust gas 84 exiting the turbine engine 10 has an exhaust pressure P5 and an exhaust temperature T5.

In one example embodiment, a bleed valve arrangement 86 is fluidly coupled to selectively bleed, based on a respective bleed angle (Θbleed), a portion (Qbleed) of the compressed air exiting the compressor by way of the outlet of power turbine 82. It will be appreciated that in certain implementations this bleeding functionality need not be carried out through the outlet of power turbine 82, as shown in the FIG. 4, but the bled air, for example, could be fed back to the inlet of compressor 24. As elaborated in greater detail below in the context of FIG. 8, in another example embodiment, a respective angle (ΘVIGV) of a variable inlet guide vane (VIGV) arrangement of the compressor may be selectively influenced.

In one example embodiment, first memory 104 (FIG. 1) stores a model (e.g., the PEMS model) of one or more systems of the turbine engine, the model is configured to predictively determine a behavior of emissions of the turbine engine. Controller 18 (FIG. 1) is operatively coupled to PEMS model to influence respective emissions levels of the emissions of the turbine engine at least based on the determined behavior of the emissions. As will be appreciated by one skilled in the art, controller 18 may be a subsystem of a control system of the turbine engine. As noted above, this embodiment involves fuel supply arrangement 20 of the turbine engine and bleed valve arrangement 86 of the compressor. A second memory 105 (FIG. 1) stores a desired emission-abatement strategy. In one example embodiment, the desired emission-abatement strategy is arranged to provide a balanced compromise amongst the respective emissions levels of the emissions of the turbine engine. In this embodiment, a split ratio of a main fuel and a pilot fuel of the fuel supply arrangement and a bleed angle of the bleed valve arrangement are concurrently adjusted by the controller in accordance with the balanced emission-abatement strategy so that the respective emissions levels of the emissions of the turbine engine are influenced during operation of the turbine to meet the balanced emission-abatement strategy.

In one example embodiment, the split ratio SPLIT and the bleed angle Θbleed are concurrently adjusted by the controller to inhibit the respective amounts of bleed air and fuel used during a steady state operation of the turbine while executing the desired emission-abatement strategy.

Directly measured parameters can be the engine inlet pressure P0, the engine inlet temperature T0, the compressor inlet temperature T1, the compressor inlet pressure P1, the compressor exit pressure P2, the compressor exit temperature T2, the turbine interduct pressure P4, the turbine interduct temperature T4, the exhaust temperature T5, the turbine engine operating temperature, the fuel flow QF, the fuel composition QH, the fuel temperature QT, the main and pilot fuel split ratio SPLIT, the bleed angle Θbleed, the respective angle ΘVIGV of the variable inlet guide vane arrangement. All these variables may be measured by one or more not shown sensors.

The used abbreviation for the turbine operating temperature depends on the turbine engine type and may be TOP, TMAX or TLIMIT and it is calculated based on some of the above measured values (not shown).

Example variables that might be inferred based on relationship parameters may be the compressor inlet pressure P1, the fuel flow QF, the fuel composition QH and the exhaust temperature T5.

Thermodynamically derived values use a combination of direct measurements and component characteristics derived from internal factory testing of the engine and examples may be the combustor exit pressure P3, the combustor exit temperature T3, an engine firing temperature TFIRE, a calculated inlet mass flow MCI.

Moreover, fundamental design characteristic of the combustion system (used in chemical kinetics model) might be considered as well and they may be a combustor component geometry or calculated or derived combustor characteristics.

P2, T2, SPLIT, QH, QF, TFIRE, P2B and MCI, Θbleed, ΘVIGV are primary input parameters to the PEMS model or the parametric model 100, respectively.

Subsequently, in step 102b KM model 102 is run over a range of input conditions. That is, the KM model 102 is executed by varying the at least one selected first state variable MCI, wherein further inputs or other input variables or selected second state variables P0, P1, P2, P3, P4, T0, T1, T2, T3, T4, T5, P2B, MCI, TFIRE, QF, QH, QT, SPLIT, Θbleed, ΘVIGV of the KM model 102 are held constant.

This may be done for several or all variable P0, P1, P2, P3, P4, T0, T1, T2, T3, T4, T5, P2B, MCI, TFIRE, QF, QH, QT, SPLIT, Θbleed, ΘVIGV individually. By varying individual boundary parameters/variables P0, P1, P2, P3, P4, T0, T1, T2, T3, T4, T5, P2B, MCI, TFIRE, QF, QH, QT, SPLIT, Θbleed, ΘVIGV while all other input parameters P0, P1, P2, P3, P4, T0, T1, T2, T3, T4, T5, P2B, MCI, TFIRE, QF, QH, QT, SPLIT, Θbleed, ΘVIGV are held constant (insofar as reasonably practical) the effect of each parameter P0, P1, P2, P3, P4, T0, T1, T2, T3, T4, T5, P2B, MCI, TFIRE, QF, QH, QT, SPLIT, Θbleed, ΘVIGV on emissions over the parameter modelling range is obtained.

Parameters/variables P0, P1, P2, P3, P4, T0, T1, T2, T3, T4, T5, P2B, MCI, TFIRE, QF, QH, QT, SPLIT, Θbleed to be varied are ones that have an equivalent ‘on-site’ direct measurement available (P0, P1, P2, P4, T0, T1, T2, T4, T5, QF, QH, QT, SPLIT), Θbleed, ΘVIGV, can be inferred from a proven relationship to other directly measured parameters (P1, P3, T3, QF, QH, T5), or be a thermodynamically derived value using a combination of direct measurements and component characteristics derived from internal factory testing of the turbine engine 10 (P3, T3, TFIRE, MCI).

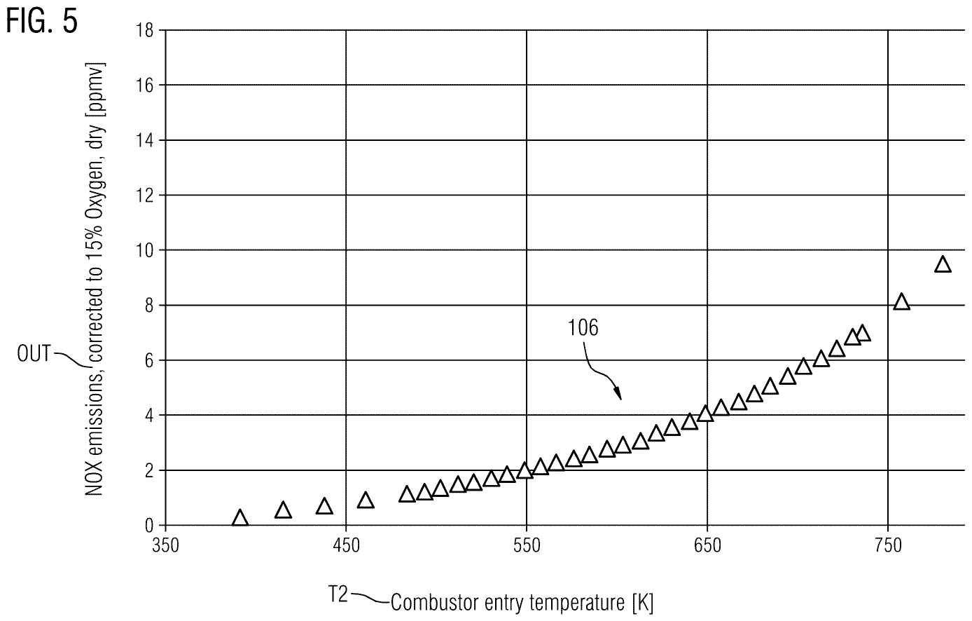

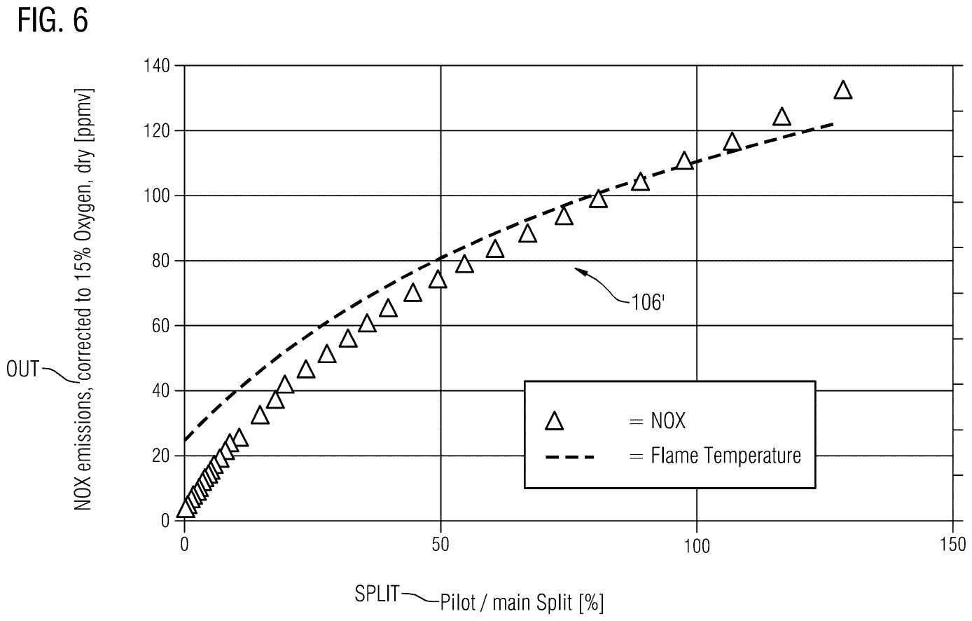

In step 102c of the model 102 emission ‘signatures’ 106, 106′ with respect to the varying of the input parameters or the selected first and second state variables P0, P1, P2, P3, P4, T0, T1, T2, T3, T4, T5, P2B, MCI, TFIRE, QF, QH, QT, SPLIT, Θbleed, ΘVIGV respectively, are obtained. The results of the variations may be represented graphically and known as the parameter ‘signature’ 106, 106′. Two exemplary signatures 106, 106′ are shown in FIGS. 5 and 6, which show each a diagram depicting the dependency of a NOx emission from a combustor entry temperature T2 (FIG. 5) and a pilot/main split ration SPLIT (FIG. 6) obtained with the CK model 102.

As can be seen in FIGS. 5 and 6 the emission behavior of the turbine engine 10 is described by using a further state variable OUT of the turbine engine (10) specifically an emission level of NOx. In other words, the further state variable OUT, which reflects the emission behavior of the turbine engine 10, represents an output of the model 102 (see also FIG. 3).

Subsequently, in step 100a (Obtaining transfer standards based on mathematical functions of emission levels) the parametrization 100 is done or the parametric model is executed. This is done by using the modelled state behavior of the variation of the at least one selected first state variable P0, P1, P2, P3, P4, T0, T1, T2, T3, T4, T5, P2B, MCI, TFIRE, QF, QH, QT, SPLIT, Θbleed, ΘVIGV, and specifically, by using a discretization resulting from the variation of the at least one selected first state variable P0, P1, P2, P3, P4, T0, T1, T2, T3, T4, T5, P2B, MCI, TFIRE, QF, QH, QT, SPLIT, Θbleed, ΘVIGV, and the modelled state behavior, especially, a modelled value of a variable of the modelled state behavior and specifically, by determining the parametrization 100 with an approximation of the discretization with a continuous function. That is, the emission signatures 106, 106′ or their graphical representations, respectively, are converted into relatively simple mathematical functions (typically polynomial expressions).

An example of such a mathematical function might be the following function, which represents the NOx emission OUT in dependency of the compressor delivery pressure PCD or the compressor exit pressure P2:

NOx=12.26+(4.93 E⁻³¹*P2⁵)+(3.157 E⁻¹⁸* P2⁵)−(1.88 E⁻²⁴*P2⁴)−(8.267 E⁻13*P2²)−(4.58 E⁻³⁸*P2⁵)−(0.0000034*P2)

In a further step 100b the predicted emissions are compared to measured data. If required the functions might be trimmed. Moreover, the mathematical functions may be validated using test and rig data and small constant offsets are permissible in order to match predicted and calculated values more accurate.

The parametrization 100 of the emission behavior of the turbine engine 10 is performed by individual parametrizations 100 for the at least one selected first state variable 0, P1, P2, P3, P4, T0, T1, T2, T3, T4, T5, P2B, MCI, TFIRE, QF, QH, QT, SPLIT, Θbleed, and for each selected second state variable P0, P1, P2, P3, P4, T0, T1, T2, T3, T4, T5, P2B, MCI, TFIRE, QF, QH, QT, SPLIT, Θbleed, ΘVIGV separately.

Furthermore, one or each individual parametrization 100 of the emission behavior of the turbine engine 10 is a depiction in a two-dimensional state space.

In general, a disclosed method comprises the steps of: parametrizing 100 the emission behavior of the turbine engine 10 for at least one selected first state variable P0, P1, P2, P3, P4, T0, T1, T2, T3, T4, T5, P2B, MCI, TFIRE, QF, QH, QT, SPLIT, Θbleed, ΘVIGV of the turbine engine 10 by using the KM model 102, which reflects a state behavior of the turbine engine 10, and determining the emission behavior of the turbine engine 10 by using the parametrization 100.

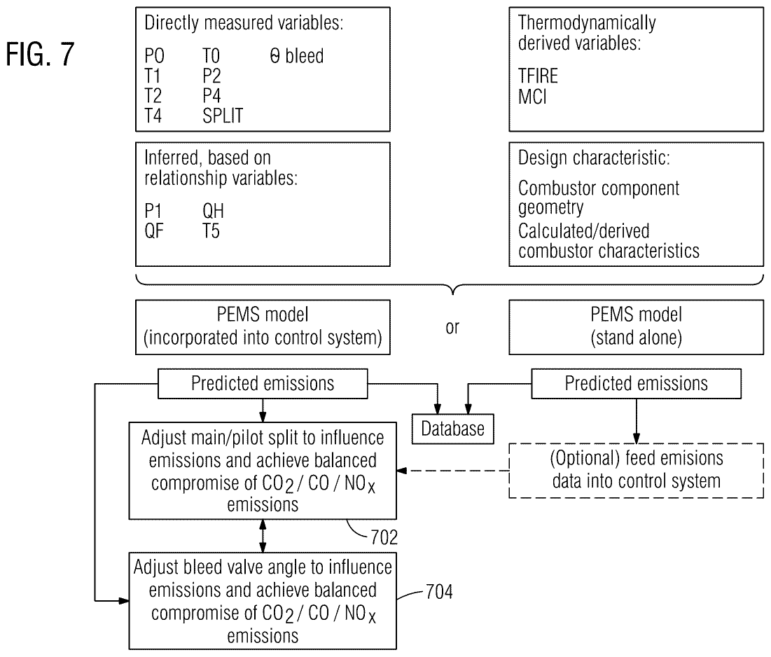

The mathematical functions are used to create a PEMS algorithm or PEMS model (see FIG. 2). The various mathematical functions representing the dependencies of the state variables P0, P1, P2, P3, P4, T0, T1, T2, T3, T4, T5, P2B, MCI, TFIRE, QF, QH, QT, SPLIT, Θbleed, ΘVIGV, OUT are incorporated into a software package. This is shown in FIG. 7 that shows a flow diagram showing two possible operational modes of a PEMS model monitoring and controlling emissions from the turbine engine 10. Then, when the turbine engine 10 is running on site, the effect of the variations of each parameter P0, P1, P2, P3, P4, T0, T1, T2, T3, T4, T5, P2B, MCI, TFIRE, QF, QH, QT, SPLIT, Θbleed, ΘVIGV, using the mathematical functions are combined to calculate predicted emissions (step 108). Thus, the parametrization 100 of the emission behavior of the turbine engine 10 is used to predict an emission behavior for predetermined values of the at least one selected first state variable P0, P1, P2, P3, P4, T0, T1, T2, T3, T4, T5, P2B, MCI, TFIRE, QF, QH, QT, SPLIT, Θbleed, ΘVIGV.

FIG. 7 shows a flow diagram representation in connection with the disclosed embodiment shown in FIG. 4. It will be appreciated that the model 102 or the resulting PEMS model may be implemented in controller 18 of the turbine engine 10 (left side of FIG. 7) or might be a standalone software package (right side of FIG. 7). As noted above in connection with the description of FIG. 4, in one example embodiment, as indicated in blocks 702 and 704, a split ratio SPLIT of a main fuel and a pilot fuel of fuel supply arrangement 20 (FIG. 4) and a bleed angle Θbleed of bleed valve arrangement 36 are concurrently adjusted or otherwise controlled by controller 18 in accordance with the balanced emission-abatement strategy so that the respective emissions levels of the emissions of the turbine engine are influenced during operation of the turbine to meet the balanced emission-abatement strategy.

The predicted emission levels may be stored in a database (step 110) or they may are fed in the engine control system (step 112) and can be used to control emission levels of the gas turbine engine 10. As noted above, this may be done by concurrently adjusting the main and pilot fuel split ratio SPLIT of the fuel supply arrangement 20 and the bleed angle Θbleed of bleed valve arrangement 36 in such a way to influence the emission level according to the prediction of the model 102 (step 114).

FIG. 8 is a schematic representation of another disclosed embodiment where fuel supply arrangement 20 and a variable inlet guide vane arrangement 802 are concurrently adjusted to achieve the desired emission-abatement strategy.

In this example embodiment, first memory 104 (FIG. 1) stores the model (PEMS model) of systems of the turbine engine. The model is configured to predictively determine a behavior of emissions of the turbine engine. Controller 18 (FIG. 1) is operatively coupled to the model to influence respective emissions levels of the emissions of the turbine engine at least based on the determined behavior of the emissions. As noted above, this embodiment involves fuel supply arrangement 20 of the turbine engine and variable inlet guide vane arrangement 802 of the compressor. Second memory 105 (FIG. 1) stores a desired emission-abatement strategy. In this embodiment, a split ratio SPLIT of a main fuel and a pilot fuel of the fuel supply arrangement 20 and a respective angle ΘVIGV of the variable inlet guide vane arrangement 802 are concurrently adjusted by the controller in accordance with the balanced emission-abatement strategy so that the respective emissions levels of the emissions of the turbine engine are influenced during operation of the turbine engine to meet the desired emission-abatement strategy.

In one example embodiment, the split ratio SPLIT and the respective angle ΘVIGV of the variable inlet guide vane arrangement 802 are concurrently adjusted by the controller to inhibit respective amounts of compressor intake flow via the variable inlet guide vane arrangement and the fuel used during a steady state operation of the turbine while executing the desired emission-abatement strategy.

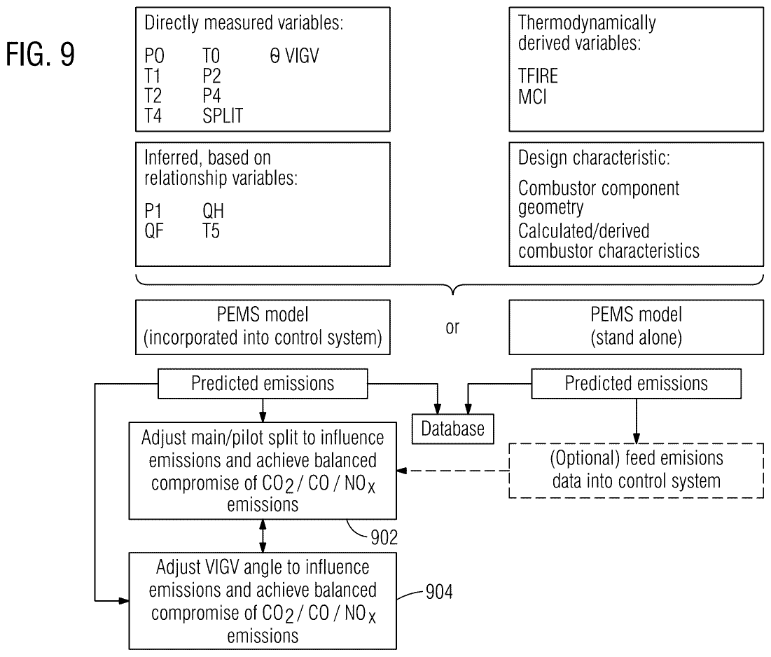

FIG. 9 shows a flow diagram in connection with the disclosed embodiment shown in FIG. 8. It will be appreciated that the model 102 or the resulting PEMS model may be implemented in controller 18 of the turbine engine 10 (left side of FIG. 9) or might be a standalone software package (right side of FIG. 9). As noted above in connection with the description of FIG. 8, in one example embodiment, as indicated in blocks 902 and 904, a split ratio SPLIT of a main fuel and a pilot fuel of fuel supply arrangement 20 and a respective angle (ΘVIGV) of variable inlet guide vane arrangement 802 of the compressor are concurrently adjusted or otherwise adjusted by the controller in accordance with the balanced emission-abatement strategy so that the respective emissions levels of the emissions of the turbine engine are influenced during operation of the turbine to meet the balanced emission-abatement strategy.

The predicted emission levels may be stored in a database (step 110) or they may be fed in the engine control system (step 112) and can be used to control emission levels of the gas turbine engine 10. As noted above, this may be done by concurrently adjusting the main and pilot fuel split ratio SPLIT of the fuel supply arrangement 20 and the respective angle (ΘVIGV) of variable inlet guide vane (arrangement 802 in such a way to influence the emission level according to the prediction of the model 102 (step 114).

As a result, disclosed embodiments can predict and optimally control emission levels (e.g., NOₓ CO, CO₂) using mathematically derived emission signatures based on chemical kinetic models of measured input parameters and thermodynamically derived parameters.

In operation, disclosed embodiments are conducive to achieving a balanced compromise amongst the respective emissions levels of the emissions of the turbine engine. That is, the emission control executed by disclosed embodiments is conducive to an optimally balanced compromise amongst the levels of NOₓ, CO, and CO₂, for example.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

It will be appreciated that other variations of our disclosed embodiments can be derived by a person skilled in the art without departing from the scope of our disclosed embodiments.

What is claimed is:

1. A turbine engine comprising:
a first memory storing a model of systems of the turbine engine, the model configured to predictively determine a behavior of emissions of the turbine engine;
a controller operatively responsive to the model to influence respective emissions levels of the emissions of the turbine engine at least based on the determined behavior of the emissions;
a fuel supply arrangement of the turbine engine;
a bleed valve arrangement of the compressor;
a second memory storing a desired emission-abatement strategy;
wherein a split ratio of a main fuel and a pilot fuel of the fuel supply arrangement and a bleed angle of the bleed valve arrangement are concurrently adjusted by the controller in accordance with the desired emission-abatement strategy so that the respective emissions levels of the emissions of the turbine engine are influenced during operation of the turbine to meet the desired emission-abatement strategy.

2. The turbine engine of claim 1, wherein the split ratio and the bleed angle are concurrently adjusted by the controller to inhibit respective amounts of bleed air and fuel used during a steady state operation of the turbine while executing the desired emission-abatement strategy.

3. The turbine engine of claim 1, wherein the desired emission-abatement strategy is arranged to provide a balanced compromise amongst the respective emissions levels of the emissions of the turbine engine.

4. The turbine engine of claim 1, wherein the turbine engine is a turbine engine.

5. A turbine engine comprising:
a first memory storing a model of systems of the turbine engine, the model configured to predictively determine a behavior of emissions of the turbine engine;
a controller operatively responsive to the model to influence respective emissions levels of the emissions of the turbine engine at least based on the determined behavior of the emissions;
a fuel supply arrangement of the turbine engine;
an inlet guide vane arrangement of the compressor;
a second memory storing a desired emission-abatement strategy;
wherein a split ratio of a main fuel and a pilot fuel of the fuel supply arrangement and a respective angle of the variable inlet guide vane arrangement are concurrently adjusted by the controller in accordance with the desired emission-abatement strategy so that the respective emissions levels of the emissions of the turbine engine are influenced during operation of the turbine to meet the desired emission-abatement strategy.

6. The turbine engine of claim 5, wherein the split ratio and the respective angle of the variable inlet guide vane arrangement are concurrently adjusted by the controller to inhibit respective amounts of compressor intake flow via the variable inlet guide vane arrangement and fuel used during a steady state operation of the turbine while executing the desired emission-abatement strategy.

7. The turbine engine of claim 5, wherein the desired emission-abatement strategy is arranged to provide a balanced compromise amongst the respective emissions levels of the emissions of the turbine engine.

8. The turbine engine of claim 5, wherein the turbine engine is a turbine engine.

9. A computer-implemented method in a turbine engine including a compressor, a fuel supply arrangement for the turbine engine, and a bleed valve arrangement of the compressor, where a non-transitory computer readable medium is programmed with computer-readable code so that when a computer processor executes the computer-readable code, the computer processor performs the following:
run a model stored in a first memory to predictively determine a behavior of emissions of the turbine engine;
operatively couple a controller to the model to influence respective emissions levels of the emissions of the turbine engine at least based on the determined behavior of the emissions;
access a second memory storing a desired emission-abatement strategy;
concurrently adjust by way of the controller a split ratio of a main fuel and a pilot fuel of the fuel supply arrangement and a bleed angle of the bleed valve arrangement in accordance with the desired emission-abatement strategy so that the respective emissions levels of the emissions of the turbine engine are influenced during operation of the turbine to meet the desired emission-abatement strategy, wherein the desired emission-abatement strategy is arranged to provide a balanced compromise amongst the respective emissions levels of the emissions of the turbine engine.

10. A computer-implemented method in a turbine engine including a compressor, a fuel supply arrangement for the turbine engine, and an inlet guide vane arrangement of the compressor, where a non-transitory computer readable medium is programmed with computer-readable code so that when a computer processor executes the computer-readable code, the computer processor performs the following:
run a model stored in a first memory to predictively determine a behavior of emissions of the turbine engine;
operatively couple a controller to the model to influence respective emissions levels of the emissions of the turbine engine at least based on the determined behavior of the emissions;
access a second memory storing a desired emission-abatement strategy;
concurrently adjust by way of the controller a split ratio of a main fuel and a pilot fuel of the fuel supply arrangement and a respective angle of the variable inlet guide vane arrangement in accordance with the desired emission-abatement strategy so that the respective emissions levels of the emissions of the turbine engine are influenced during operation of the turbine to meet the desired emission-abatement strategy, wherein the desired emission-abatement strategy is arranged to provide a balanced compromise amongst the respective emissions levels of the emissions of the turbine engine.
